(19) United States
(12) Patent Application Publication
(10) Pub. No.: US 2017/0230414 A1
(43) Pub. Date: Aug. 10, 2017

(54) IDENTIFYING AND DETERMINISTICALLY AVOIDING USE OF INJECTED OR ALTERED QUERY FILES

(71) Applicant: Avocado Systems Inc., San Jose, CA (US)

(72) Inventor: Keshav G. Kamble, Fremont, CA (US)

(21) Appl. No.: 15/424,749

(22) Filed: Feb. 3, 2017

Related U.S. Application Data
(60) Provisional application No. 62/290,950, filed on Feb. 4, 2016.

(51) Int. Cl. H04L 29/06; G06F 21/62

(52) U.S. Cl. CPC H04L 63/1466; H04L 63/101; G06F 21/6227

(57) ABSTRACT

In one embodiment, a method includes obtaining a list of registered applications, each application indicated by the list having been provided permission and authenticated to operate within a network. The list includes: an identifier, one or more first hash values obtained individually for each of the registered applications, and a plurality of second hash values obtained individually for each dependent file associated with each of the registered applications. The method also includes detecting unauthorized alterations of and injections into the dependent files associated with each of the registered applications based on the list, and performing an action in response to detecting unauthorized alterations of and injections into the dependent files. Other systems, methods, and computer program products are described in accordance with more embodiments.

### FIELD OF THE INVENTION

The present invention relates to network and system protection, and more particularly, this invention relates to identifying injected or altered query files using an application and data protection layer (ADPL) and deterministically avoiding use of such query files.

### BACKGROUND

Applications are made up of a large number of instructions and data. Instructions operate on data which is fetched in a cache and memory and is always unencrypted. Scaled-out, distributed applications are made up of a large number of application instances. These application instances have their own data in the cache and memory of the processor on which these applications run. A large number of such application instances communicate with each other and process data in parallel to create an aggregate output.

These types of scaled-out applications are extremely vulnerable to application breaches, data thefts from cache and memory by scraping, and other methods of illicitly obtaining data from the applications, cache, and/or memory. In data centers which cater to important applications and data types, such as Personally Identifiable Information (PII), Payment Card Industry (PCI) data, medical information that falls under Health Insurance Portability and Accountability Act (HIPAA), military and Government critical tasks, any application and/or data breach is very destructive and expensive to contain and/or resolve. Therefore, it is beneficial to attempt to prevent such breaches.

Structured Query Language (SQL) injection is a type of attack on data centric applications which involves using query language files to retrieve or access application databases which are altered by injecting additional code into the databases. The additional code is typically directed at opening and obtaining private data or initiating hacks, stealing information, destroying information, and/or other malicious behavior. Unfortunately, this type of injection or alteration of any type of files occurs with illicitly obtained or stolen credentials, and therefore can proceed undetected for long periods of time.

Currently, there are no deterministic methods of identifying the breach and catching the source of the unauthorized session through which injection occurs. Moreover, there are currently no methods of identifying the injected files or unauthorized and altered portions of existing files. SQL injection has been one of the most dangerous types of attacks on enterprise data centers and data center applications in recent years. Large amounts of sensitive data are being compromised, accessed, and stolen by hackers using these types of attacks.

### SUMMARY

In one embodiment, a method includes obtaining a list of registered applications, each application indicated by the list having been provided permission and authenticated to operate within a network. The list includes: an identifier of one or more registered applications, one or more first hash values, each of the one or more first hash values being obtained individually for each of the one or more registered applications and being stored in correlation with an identifier of a corresponding one of the one or more registered applications, and a plurality of second hash values, each of the plurality of second hash values being obtained individually for each of one or more dependent files associated with each of the one or more registered applications and being stored in correlation with the identifier of the corresponding one of the one or more registered applications. The method also includes detecting unauthorized alterations of and injections into the one or more dependent files associated with each of the one or more registered applications based on the list, and performing an action in response to detecting unauthorized alterations of and injections into the one or more dependent files.

According to another embodiment, a computer program product includes a computer readable storage medium having program instructions stored thereon. The program instructions are executable by a processing circuit to cause the processing circuit to obtain a list of registered applications, each application indicated by the list having been provided permission and authenticated to operate within a network. The list includes: an identifier of one or more registered applications, one or more first hash values, each of the one or more first hash values being obtained individually for each of the one or more registered applications and being stored in correlation with an identifier of a corresponding one of the one or more registered applications, and a plurality of second hash values, each of the plurality of second hash values being obtained individually for each of one or more dependent files associated with each of the one or more registered applications and being stored in correlation with the identifier of the corresponding one of the one or more registered applications. The program instructions are also executable by the processing circuit to cause the processing circuit to detect unauthorized alterations of and injections into the one or more dependent files associated with each of the one or more registered applications based on the list, and perform an action in response to detecting unauthorized alterations of and injections into the one or more dependent files.

In yet another embodiment, a system includes a processing circuit and logic integrated with and/or executable by the processing circuit. The logic causes the processing circuit to obtain a list of registered applications, each application indicated by the list having been provided permission and authenticated to operate within a network. The list includes: an identifier of one or more registered applications, one or more first hash values, each of the one or more first hash values being obtained individually for each of the one or more registered applications and being stored in correlation with an identifier of a corresponding one of the one or more registered applications, and a plurality of second hash values, each of the plurality of second hash values being obtained individually for each of one or more dependent files associated with each of the one or more registered applications and being stored in correlation with the identifier of the corresponding one of the one or more registered applications. The logic also causes the processing circuit to detect unauthorized alterations of and injections into the one or more dependent files associated with each of the one or more registered applications based on the list, and perform an action in response to detecting unauthorized alterations of and injections into the one or more dependent files.

The embodiments described above may be implemented in any computing system environment known in the art, such as a networking environment, which may include a processor and a computer readable storage medium configured to store data and logic, the logic being implemented with and/or executable by the processor to cause the processor to perform one or more functions.

### BRIEF DESCRIPTION OF THE DRAWINGS

The following descriptions of the drawings are not meant to be limiting on what is taught by the drawings in any manner. For a fuller understanding of the content of each drawing, the following brief descriptions are provided, which when read in conjunction with the detailed description, describe the full breadth of the various embodiments of the present invention.

FIG. 1 shows a network architecture, according to one embodiment.

FIG. 2 shows a hardware environment that may be associated with the network architecture of FIG. 1, according to one embodiment.

FIG. 3 shows a logical representation of an application instance operating on a computing system, in accordance with one embodiment.

FIG. 4 shows several application instances operating in a virtual environment, according to one embodiment.

FIG. 5 shows an exchange of capabilities with intermediate devices and peer applications, according to one embodiment.

FIG. 6 shows a flowchart of a method, according to one embodiment.

### DETAILED DESCRIPTION

The descriptions presented herein are intended to enable any person skilled in the art to make and use the present invention and are provided in the context and requirements of particular applications of the present invention.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an,” and “the” include plural referents unless otherwise specified.

Moreover, the term “about” when used herein to modify a value indicates a range that includes the value and less and greater than the value within a reasonable range. In the absence of any other indication, this reasonable range is plus and minus 10% of the value. For example, “about to milliseconds” indicates 10 ms±1 ms, such that the range includes all values in a range including 9 ms up to and including 11 ms.

Also, the term “comprise” indicates an inclusive list of those elements specifically described without exclusion of any other elements. For example, “a list comprises red and green” indicates that the list includes, but is not limited to, red and green. Therefore, the list may also include other colors not specifically described.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown and described herein, but is to be accorded the widest scope consistent with the principles and features disclosed herein.

In particular, various embodiments of the invention discussed herein may be implemented using a network, such as the Internet, to communicate among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN), or other communication media. In addition, various combinations of wired (e.g., Ethernet), wireless (e.g., radio frequency) and optical communication links (e.g., fiber optic) may be utilized.

The term application as used herein refers to any type of software and/or hardware-based application, such as enterprise data center applications, Internet-of-Things (IOT) applications, Industrial control applications, military applications, etc.

Enterprise data center applications may include any of the following application types: financial applications, equity trading applications, healthcare applications, financial transaction applications, etc.

IOT applications may include any of the following application types: mobile communication applications, home automation/control applications, industrial automation/control applications, security and monitoring applications, etc.

Industrial control applications may include any of the following application types: nuclear power plant control, thermal power plant control, hydro-electric power plant control, wind farm control, electricity grid and distribution control, water treatment control, land-based traffic control, air traffic control, etc.

Military applications may include any of the following application types: military installation control, first alert system control, autoguided weapon system control, military weaponized equipment control including manned vehicles, weaponized and/or surveillance-oriented unmanned vehicle control (drones) such as unmanned aerial vehicles (UAVs), unmanned aircraft systems (UASs), unmanned underwater vehicles (UUVs), unmanned ground vehicles (UGVs), etc.

A program environment in which one embodiment may be executed illustratively incorporates one or more general-purpose computers and/or special-purpose devices, such as switches, routers, switch controllers, etc. Details of such devices (e.g., processor, memory, data storage, input devices, and output devices) are well known and are omitted for the sake of clarity.

It should also be understood that the techniques of the present invention may be implemented using a variety of technologies. For example, the methods described herein may be implemented in software running on a computer system, implemented in hardware utilizing one or more hardware processors and logic (hardware logic and/or software logic) implemented with and/or executable by the hardware processor. The logic is configured to cause the processor to perform operations of a method, and may take any form known to those of skill in the art, such as application specific integrated circuits (ASICs), programmable logic devices such as Field Programmable Gate Arrays (FPGAs), and/or various combinations thereof.

In one illustrative approach, methods described herein may be implemented by a series of computer-executable instructions stored to a computer readable storage medium, such as a physical (e.g., non-transitory) data storage medium. In addition, although specific embodiments may employ object-oriented software programming concepts, the present invention is not so limited and is adaptable to employ other forms of directing the operation of a processor.

The present invention may also be provided in the form of a computer program product comprising a computer readable storage medium having program instructions thereon or a computer readable signal medium having program instructions therein, which may be executed by a computing device (e.g., a processor) and/or a system. A computer readable storage medium may include any medium capable of storing program instructions thereon for use by a computing device or system, including optical media such as read only and writeable CDs and DVDs, magnetic memory or media (e.g., hard disk drive, magnetic tape, etc.), semiconductor memory (e.g., FLASH memory, non-volatile random access memory (NVRAM), and other non-volatile storage media known in the art), firmware encoded in a microprocessor, etc.

A computer readable signal medium is one that does not fit within the aforementioned computer readable storage medium definitions. For example, illustrative computer readable signal media communicate or otherwise transfer transitory signals within a system, between systems, etc., e.g., via a physical or virtual network having a plurality of connections.

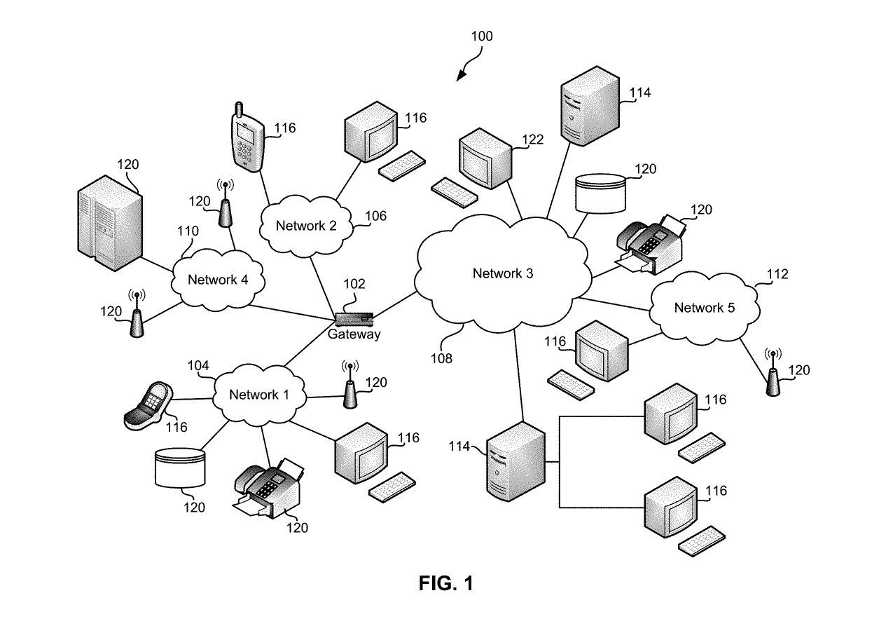

FIG. 1 illustrates an architecture 100, in accordance with one embodiment. As an option, the present architecture 100 may be implemented in conjunction with features from any other embodiment listed herein, such as those described with reference to the other figures. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks are provided including a first remote network 104 and a second remote network 106. A gateway 102 may be coupled between the remote networks 104, 106 and a proximate network 108. In the context of the present network architecture 100, the networks 104, 106 may each take any form including, but not limited to, a LAN, a WAN such as the Internet, a storage area network (SAN), a public switched telephone network (PSTN), an internal telephone network, etc. Additional networks 110, 112 may also be connected via the gateway 102 or some other connection device known in the art. These networks may be of a different type than the networks 104, 106. For example, network 110 may be a network devoted to the IOT, and may provide infrastructure and protocols for communication between all devices in the IOT, and between any devices in the IOT and the networks 104, 106. In another example, network 112 may be a network devoted to Industrial control, and may provide infrastructure and protocols for communication within and/or between facilities anywhere in the world, including automated devices, manufacturing lines, assembly lines, processing control software, etc.

In use, the gateway 102 serves as an entrance point from the remote networks 104, 106 to the proximate network 108. As such, the gateway 102 may function as a router, which is capable of directing a given packet of data that arrives at the gateway 102, and a switch, which furnishes the actual path in and out of the gateway 102 for a given packet.

Further included in the network architecture 100 is at least one data server 114 coupled to the proximate network 108, and which is accessible from the remote networks 104, 106 via the gateway 102. It should be noted that the data server(s) 114 may include any type of computing device/groupware. Coupled to each data server 114 is a plurality of user devices 116. User devices 116 may include any device known by those of skill in the art, such as a desktop computer, a laptop computer, a hand-held computer, a smartphone, a terminal, a port, a printer, some type or form of logic, etc. It should be noted that a user device 122 may also be directly coupled to any of the networks, in one embodiment.

A peripheral 120 or series of peripherals 120, e.g., facsimile machines, printers, networked storage units, hard disk drives, wireless routers, etc., may be coupled to one or more of the networks 104, 106, 108, 110, 112. It should be noted that databases, servers, mainframes, and/or additional components may be utilized with and/or integrated into any type of network element coupled to the networks 104, 106, 108, 110, 112. In the context of the present descriptions, a network element may refer to any component of a network, system, device, and/or any device useable in a network.

According to some approaches, methods and systems described herein may be implemented with and/or utilized on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of virtualization software, such as VMWARE ESX, MICROSOFT HYPER-V, SIMICS, etc., in some embodiments.

In more approaches, one or more of the networks 104, 106, 108, 110, 112 may represent a cluster of systems commonly referred to as a “cloud.” In cloud computing, shared resources, such as processing power, peripherals, software, data processing, servers, storage, etc., are provided to any system that has access to the cloud and permission to access the specific resource, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used as would be understood by those of skill in the art.

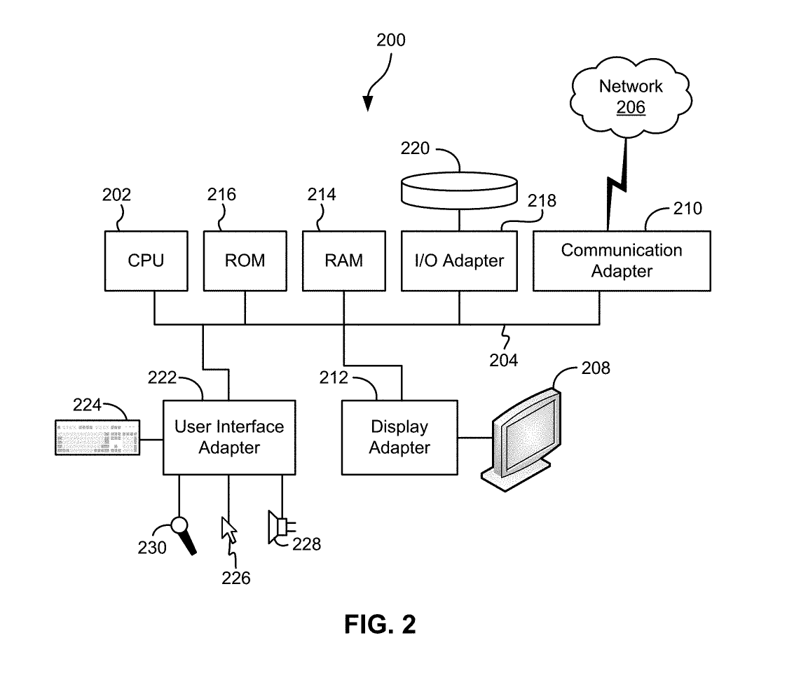

FIG. 2 shows a representative hardware environment associated with a user device 116 and/or a server 114 of FIG. 1, in accordance with one embodiment. FIG. 2 illustrates a typical hardware configuration of a workstation 200 having a central processing unit 202, such as a microprocessor, and a number of other units interconnected via a system bus 204.

The workstation 200 shown in FIG. 2 includes a Random Access Memory (RAM) 214, Read Only Memory (ROM) 216, an I/O adapter 218 configured to connect peripheral devices, such as disk storage units 220 to the bus 204, a user interface adapter 222 configured to connect a keyboard 224, a mouse 226, a speaker 228, a microphone 230, and/or other user interface devices such as a touch screen, a digital camera, etc., (not shown) to the bus 204, communication adapter 210 configured to connect the workstation 200 to a communication network 206 (e.g., a data processing network) and a display adapter 212 configured to connect the bus 204 to a display device 208.

The workstation 200 may have resident thereon an operating system, such as the MICROSOFT WINDOWS Operating System (OS), a MAC OS, a UNIX OS, etc. It will be appreciated that a preferred embodiment may also be implemented on platforms and operating systems other than those specifically mentioned herein. A preferred embodiment may be written using JAVA, XML, C, and/or C++ language, SCALA, COBOL, FORTRAN, or other programming languages, along with an object oriented programming methodology or scripting language such as PERL, PYTHON, Tcl/Tk, or other scripting languages. Object oriented programming (OOP), which has become increasingly used to develop complex applications, may also be used.

Moreover, one or more hardware processors may be implemented in a processing circuit in the workstation 200. The processing circuit includes the one or more hardware processors, along with any connections or links therebetween necessary to interconnect the one or more processors in the processing circuit. In addition, the processing circuit may be implemented with logic and/or may be configured to execute logic, with the logic being configured to cause the processing circuit to perform functionality specified by the logic.

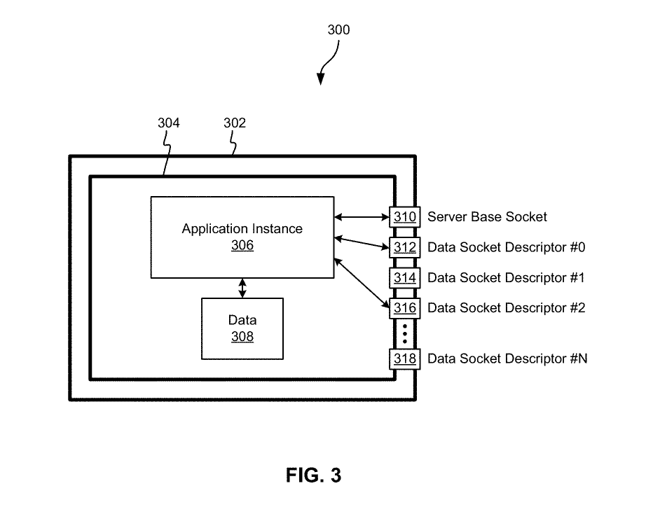

Now referring to FIG. 3, a logical representation of an application instance 306 operating on a computing system 300 is shown according to one embodiment. Although only one application instance 306 and one set of data 308 is shown in FIG. 3, as would be understood by one of skill in the art, any number of application instances and groups of data may be hosted on a computing system 300, limited only by the processing power and/or other resources available to the computing system 300.

As shown in FIG. 3, an application protection layer (APL) 302 and a data protection layer (DPL) 304 are represented within the computing system 300, according to one embodiment. The application instance 306 has access to data 308 within the computing system 300. Also, the application instance 306, through any number of standard and/or custom APIs, may utilize any of a plurality of data socket descriptors (e.g., data socket descriptor #0 312, data socket descriptor #1 314, data socket descriptor #2 316, . . . , data socket descriptor #N 318) with which to communicate (send and/or receive) information outside of the application instance 306 or computing system 300. One or more server base sockets 310 is provided in the application instance 306 of computing system 300 and is used for control of the peer application instances on the computing system 300, outside the system, or outside the application instance 306 itself, as would be understood by one of skill in the art.

Many, but not all, scaled-out enterprise applications, such as those used in the fields of finance, banking, stock market investing, monetary analytics, web traffic analytics, data analytics, web searching, etc., have built-in capabilities that allow an individual instance of a scaled-out distributed application to protect itself from malicious software and data breaches. Many of the operating systems on which these scaled-out enterprise applications operate also have capabilities to protect themselves from external denial of service attacks, application vulnerability attacks, data stealing malware attacks, etc. The individual applications and operating systems perform these security capabilities using multiple built-in techniques, some of which are discussed below. For example, most database systems have the following capabilities:
1. Policy-based data redaction
2. Programmable cache flushing
3. Memory protection or locking
4. Database locking (including locking one or more individual rows and/or columns of a database)
5. Secure Socket Layer (SSL) capabilities to encrypt transport payload(s)
6. Partial application-payload encryption
7. Distributed denial of service (DDoS) checks
8. Protocol anomaly checks
9. Other standard and proprietary protections not listed above

Although, these features partially protect an individual application instance or database, they fail to protect the complete distributed application system as a scaled out and/or distributed application. Various parts or portions of the application have differing capabilities to protect themselves. When the applications in a data center or enterprise are allowed to exchange their own capabilities of protection with each other using secure exchange information, the complete application ecosystem would be allowed to take advantage of the individual application's capabilities and enable a correct or most appropriate response decision about the systemic and session level security issues facing one or more distributed application instances.

In order to provide application and data protection to application instances of distributed, scaled-out applications which have instances operating on a plurality of computing systems, at least two operations may be performed, and are described below according to one embodiment.

In a first operation, application instances, such as application instance 306, are identified based upon data socket descriptor attributes that an application instance uses to communicate between other application instances and/or group(s) of application instances on/or outside of the computing system 300. For example, in response to application instance 306 utilizing data socket descriptor #0 312 consistently to communicate with another system, an association may be established between data socket descriptor #0 312 and the application instance 306. By consistently, what is meant is that application instance 306 utilizes data socket descriptor #0 312 to communicate with another system more than a predetermined number of times within a given period of time, according to one embodiment. In another embodiment, consistently utilizing a data socket descriptor means that only a specific data socket descriptor is used in exclusion of all others over a given period of time.

In a second operation, a group is formed which includes any application instance which has all of the same socket descriptor attributes (or at least a predetermined amount of the same socket descriptor attributes, or the same of a certain group of socket descriptor attributes), e.g., data exchange sockets of the same application base socket, transport protocol, server port, various multi-tenancy characteristics, storage characteristics, payload sizes, container attributes, and/or multiple time contexts are grouped together.

Any socket descriptor attributes may be considered when determining whether an application instance shares data socket descriptor attributes with another application instance, such as OS and container attributes which include server port, transport protocol, network address translation (NAT) IP address range, maximum transmission unit (MTU), application payload sizes, user programmable attributes such as multi-tenancy labels etc.

Using the above two operations, two layers of protection (application protection and data protection) are enacted together to protect the application (not shown) from which the application instance 306 is provided and any group of application instances related to the application that provides the application instance 306.

FIG. 3 shows the Application and Data Protection Layer (ADPL) libraries which keep track of the server base socket 310 and various data socket descriptors 312, 314, 316, . . . , 318 opened by an application instance 306 for communication of data with one or more peer applications outside of the computing system 300. The data socket descriptors 312, 314, 316, . . . , 318 are used for the exchange of data with another system outside of the computing system 300.

The data socket descriptors 312, 314, 316, . . . , 318 are numbers that represent attributes and/or characteristics of different data exchanges between the application instance and one or more receiver hosts. Each data socket descriptors 312, 314, 316, . . . , 318 may have a size ranging from 12 to 48 bits, such as 32 bits in one embodiment.

Each of the Application Protection Layer (APL) 302 and the Data Protection Layer (DPL) 304 utilize individual sets of application programming interfaces (APIs) that are configured to piggyback on existing APIs, but add specialized functionality to any action performed using the existing APIs.

These new socket APIs and data protection APIs, and the type of application payload sent and received, do not disturb the intermediate security appliances such as firewall, Intrusion Prevention and Intrusion Detection, etc.

The application instance 306 utilizes the one or more server base socket(s) 310 with standard and/or private well-known port number(s) as a control socket, but opens a new data socket descriptor and allocates a different port number to the new data socket descriptor in order to handle actual functionality and data transfer between the computing system 300 and any other external or peer system.

The server base socket 310 has the following attributes and/or characteristics:
10. A server and/or a source internet protocol (IP) interface.
11. A standard and/or known server port number, e.g., transmission control protocol (TCP) port, user datagram protocol (UDP) port, etc.
12. A maximum number of allowable waiting connections.
13. A maximum (and possibly minimum) application packet buffer size usable for transmitting and receiving data.
14. Other socket options provided by the operating system, the user, or an external input.

The above described attributes and/or characteristics may also be attributed to the plurality of allocated data socket descriptors 312, 314, 316, . . . , 318. When a connection is established between the computing system 300 and another system via the application instance 306, a data socket descriptor is allocated. The allocated data socket descriptor has the following attributes and/or characteristics:
1. A server and/or a source IP interface.
2. A standard and/or known server port number, e.g., TCP port, UDP port, etc.
3. A maximum number of allowable waiting connections.
4. Application packet buffer size for transmit and receive.
5. A port number of the transport of the allocated data socket descriptor (in the computing system 300).
6. An IP address of the peer data socket descriptor (in an external system) of the allocated data socket descriptor (usually, but not always, in TCP sockets).
7. A port number of the transport of the peer data socket descriptor of the allocated data socket descriptor in all cases of controlled port allocations by the application instance 306.
8. A maximum (and possibly minimum) application packet buffer size usable for transmitting data to and receiving data from (transmissions with) the peer data socket descriptor.

Apart from the above described characteristics and/or attributes, additional characteristics that may be attributable to an allocated data socket descriptor include:
9. A first identifier (ID1): a globally unique identification number given for an entity (such as an enterprise, company, university, city subdivision, etc.) that utilizes the ADPL mechanism in the application instances or programmed for proprietary purposes
10. A second ID (ID2): a unique identification number within the entity (not necessarily globally unique). Each ID2 represents a subdivision within the entity, such as an individual business unit within an enterprise, a water district within a city, etc., or programmed for proprietary purposes.
11. Secure base signature: a base signature or scrambled alphanumeric or numerical code used in the generation of signatures per data socket descriptor.
12. Secure runtime signature: a scrambled alphanumeric or numerical code used as a signature on a per data socket descriptor basis.
13. Application name: a name given to the application instance operating on the computing system.
14. Application ID: an identification number provided to the application instance operating on the computing system.
15. Process ID: an identification number provided to a particular process which is accountable for the data.
16. Server port: the particular port on the server on which data is received or sent.
17. Transport protocol: the particular transport protocol used to send data.
18. Base Crypto Version: the version of the cryptographic process used to encrypt data.
19. Co-Lo Need: Co-locationing criterions where applications or application instances may reside together in the same server, server pool, rack, pod, or data center.
20. Architecture Tier: a tier within the system architecture on which the (web, application, database, etc.) operates.
21. Storage Attachments: an attribute that describes how the storage is attached to the computing system (e.g., direct, network, distributed, etc.)
22. Proprietary Multi-Tenant Label: a label within the ADPL tag which designates some information selectable by the user.

These unique attributes when combined together in one of many different variations, are able to identify a data socket descriptor, and locks that data socket descriptor to one particular instance of a scaled-out application group.

Highly scaled-out and distributed enterprise applications typically run on physical servers with about 2 TB of DRAM and 32 MB of cache, or more. When access to a database is requested, the whole database in un-encrypted form is fetched into the memory (in-memory) and held in clear-text for processing. This mechanism is referred to as “in-memory database.” In-memory database processing provides a performance boost of almost 200 times over conventional processing which relies on fetching database records from disk storage to memory. In-memory database processing also involves processing whole rows or columns of data in cache. Although, these types of enterprise application architectures provide very high performance and scalability, they suffer from application and data security challenges. These applications exchange huge amounts of data in an East-West (E-W) manner with instances of the application. A huge amount of E-W communication and a huge amount of data in memory and cache causes these application instances to be prime targets for data breaches and/or application breaches.

In use cases like data center applications, there are two types of data traffic components: North-South (N-S) traffic and E-W traffic. N-S traffic is sent by internet-based clients and/or servers, to data center-based servers. It is mostly related to client queries, server responses, etc. This N-S interaction is exposed to hacking and data breaches since it occurs over public internet and communication links. Such interactions are usually highly encrypted for security purposes.

E-W traffic is generated within the data center by the application servers and sent therebetween in response to N-S interactions. The data traffic or interactions that are generated by application servers within themselves for regular non-query based purposes are also referred to as E-W traffic. Since E-W communication occurs within the data center behind a firewall, typically E-W communication is not encrypted. Encrypting/decrypting such data may cause performance degradation of the data center application.

Usually, application security is attempted by applying policies and rules at various levels in security appliances and/or load balancing appliances in data centers. However, in spite of providing layers of security appliances to create a security perimeter, polymorphic malware and malicious software is able to enter inside the servers in the data center to steal data and attack applications. Enterprise database applications for financial companies, such as banks, insurance companies, and credit card companies, are extremely vulnerable to data theft by various methods and various types of attacks, including spoofing, cache scraping, memory scraping, etc. Spoofing occurs when malicious code mimics real application transmission in order to obtain data that it is not authorized to obtain. Cache scraping occurs when malicious code searches the cache for data that may be sensitive in nature and copies the data or strips some or all of the data from the cache so that it may be utilized by inappropriate entities. Memory scraping is similar, except that the memory may hold large amounts of application data as well as the in-memory database which receives attacks for data stored therein.

However, due to breaches in the data center, such E-W communication is also exposed to malware applications which are able to attack application and data using awareness of the communication mechanism used by the data center application.

According to embodiments included herein, identification of injected query files, such Structured Query Language (SQL) query files, is possible, along with identification of a time of injection. Also, users of events resulting from the injected code may be warned, and these query files may be deterministically stopped or quarantined in response to detection of the injection, as appropriate, thereby preventing data loss, corruption, etc.

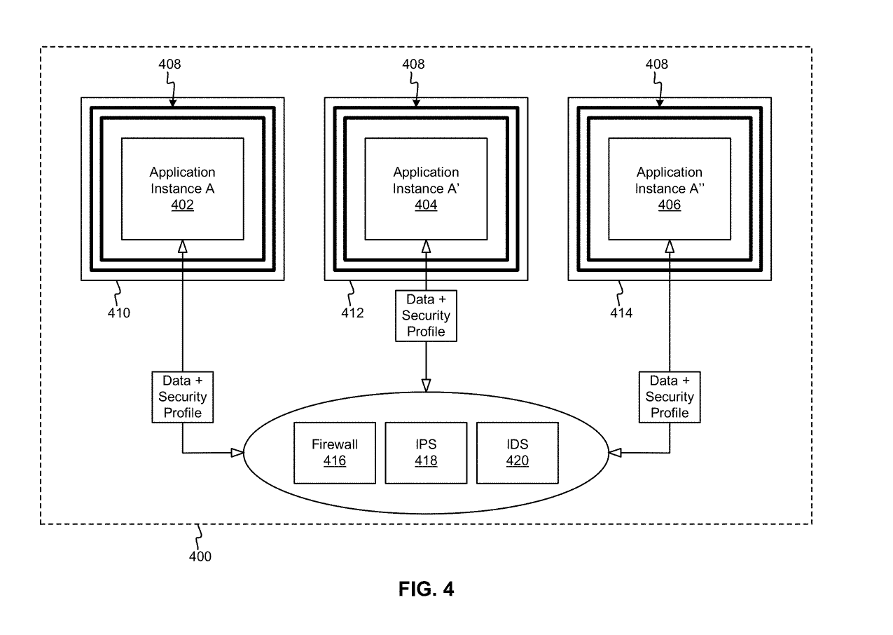

Now referring to FIG. 4, three instances of an application, Application instance A 402, Application instance A′ 404, and Application instance A″ 406 are shown running in a virtual environment 400 on one or more virtual platforms, such as hypervisors. An ADPL 408 provided by secure APIs called by the hosts, Host A 410, Host A′ 412, and Host A″ 414, enables application protection via policies and also provides data protection by sharing a security status and security profile with any peer application instances operating on other hosts (Application instance A 402 is a peer to Application instance A′ 404, Application instance A′ 404 is a peer to Application instance A″ 406, Application instance A″ 406 is a peer to Application instance A 402, and so forth). Using the security profile of the peer application instance, the protected application instance is provided the capability to apply various data security mechanisms to protect itself from malicious code and data breach attacks.

New data socket APIs and data protection APIs that are utilized to provide the protection do not disturb any intermediate security appliances used in the network and/or on the servers or hosts, such as a firewall 416, an Intrusion Prevention System (IPS) 418, an Intrusion Detection System (IDS) 420, etc.

The new data socket APIs and/or libraries are used to exchange information regarding an application or application instance's (e.g., application instance 402, 404, 406, etc.) own security capabilities with other peer applications and application instances (e.g., application instance 402, 404, 406, etc.), as well as to exchange and/or provide information regarding the application or application instance's (e.g., application instance 402, 404, 406, etc.) own security capabilities to one or more various security devices, security appliances, etc. (e.g., firewall 416, IPS 418, IDS 420, etc.), that may be operating within a network or data center (e.g., virtual environment 400).

Through similar APIs, applications and application instances (e.g., application instance 402, 404, 406, etc.) receive security capabilities and interpret these received security capabilities from other peer applications and application instances (e.g., application instance 402, 404, 406, etc.) to understand what sort of security each peer application and application instance (e.g., application instance 402, 404, 406, etc.) is capable of. This process does not interfere with the application architecture and its normal behavior. Through this exchange process, each application and application instance (e.g., application instance 402, 404, 406, etc.) is afforded additional capabilities for infrastructural help and to know the security capabilities of virtual and/or physical servers (e.g., Host A′ 410, Host A″ 412, Host A′″ 414, etc.) that execute the applications and application instances (e.g., application instance 402, 404, 406, etc.) within the network and/or data center, the security capabilities of other peer applications and application instances (e.g., application instance 402, 404, 406, etc.) and their virtual and/or physical servers, etc. Moreover, the ADPL which protect the applications and application instances (e.g., application instance 402, 404, 406, etc.) by protecting the data socket descriptors may also receive the applications' and application instances' capabilities and in return, utilize these capabilities to cause applications and application instances (e.g., application instance 402, 404, 406, etc.) to use these capabilities dynamically depending upon security profiles of individual sessions.

The security profiles of individual sessions are obtained by the ADPL 408 using its built-in capability for distributed applications. Based on the comprehensive status of servers and the network, the APIs provide feedback per data socket descriptor to the applications and application instances (e.g., application instance 402, 404, 406, etc.) and also suggests use of their own security capabilities to protect themselves as well as to clear data being exchanged with peers or clients.

The ADPL 408 around the socket descriptors for database applications creates a mapping of security profile policies with the application per data socket descriptor to perform various security feature functionality, such as dynamic cache flush, dynamic data redaction, locking of in-memory database(s), etc. These security features are configured to be applied on a per application instance per session basis. As a result, a database server is allowed to enact a dynamic security feature depending upon the security profile of that particular session at that time, thereby avoiding cache scraping, data breaches, or other unwanted intrusion by malware or nefarious applications.

The ADPL 408 seamlessly couples to each application instance via socket APIs to provide this deterministic injection response. Some of the features of the ADPL 408 include: segmentation at the lowest level in communication mechanisms, i.e., the data socket descriptor, enforcement of segmentation, policy management and enforcement, configuration and statistics exchange with an external configuration manager, binary scanning of applications operating within the network and signature verification (using any known hashing algorithm, such as MD5Sums, SHA-1, SHA-2, SHA-256, etc.), application registry and tracking. Any of these functions may be independently performed by the ADPL 408, or via assistance from an orchestrator that is in communication with all ADPL instances within the network.

The ADPL 408 provides query injection detection and prevents the use of injected query files via the use of binary scans (hash value generation) and signature verification methods, as described herein in various embodiments.

In one embodiment, a global list, table, or database of registered applications is maintained (such as at the orchestrator) with the scan signatures (hash values obtained) of each application that is registered to operate within the network. This list is stored on a separate server from any server that operates applications within the network to maintain its independence from corrupting application execution.

Another list is maintained that includes query language files used by each of the registered application along with scan signatures (hash values obtained) of each query language file. This list may be included in the global list, or maintained separately inside each instance of the ADPL 408.

Moreover, session level logic is operated for each application for application and query language file checks. In addition, an interaction control module and interaction protocol may be operated between each application server and the orchestrator.

The global list of registered applications is prepared, held, and maintained by the central configuration manager server or central server functionality which is capable of communication with all the applications deployed within each instance of the ADPL 408. The purpose of this global list is as a global reference of authenticated applications in the data center, branch office, central office, or some other distinguishing characteristic of the network. It servers the same purpose for IOT and Industrial Control applications.

The global list of registered applications may include a plurality of fields. Some possible fields are described as follows:

Application Identifier: a field which includes a unique or semi-unique indication of the application, such as the name of the application being registered. The values of this field may be obtained through manually registering the application or by an auto-discovery process run by the ADPL 408.

Application Path: a field which includes a path of the application selected by the Dev-Ops organization which is also the path of the application on the local storage device.

Application Signature Scan: a field which includes a binary hash scan (value) obtained from an executable file of the application, such as a MD5Sum scan. This field is provided by the application administrator while registering the application (manually or via script). This is one of the many signatures used to identify an application operating in the network. This field is referred to and compared with a value obtained from a real application instance every time it is spawned in the network on various servers. The ADPL 408 on that server calculates the signature scan of the application being spawned or application that is calling a standard operating system API(s) which can be intercepted by the ADPL 408. The scan signature is then sent for comparison with the registered signature for verification.

Additional Application Signature Scan(s): one or more field which include additional binary hash scans of the application's executable file, such as SHA-1, SHA-2, etc. These fields are provided by the application administrator while registering the application (manually or via script). This is one of the many signatures used to identify the application. These fields are referred to and compared with real application instances when they are spawned every time on various servers in the network. The ADPL 408 on that server calculates a hash scan of the application being spawned or application which is calling standard operating system APIs which can be intercepted by the ADPL 408. The scan signature is then sent for comparison with the registered signature for verification.

Last Check Time: a field which includes a time stamp when this row was last referred for checks, which also informs about a last time hash scans of this registered application were sent for checks. Using this time stamp, additional list optimization may be achieved by identifying frequently referred rows and moving them up in the list for faster searching.

Query File Index/Pointer: a field which includes a pointer or index to the list which holds a list of query files and paths thereof related to a particular application. The index is in secure form (encrypted in the list and is decrypted only when used).

Combined scan of query scan files: a field which includes an accurate hash of a file which stores all scans of the query files used by this particular application. The list of query files are listed in the table pointed to by Query File Index or Pointer. Every verification procedure compares this scan with the scans sent by the requesting entities.

The Query Files List includes another set of fields, which may include any of the following fields and those not specifically described herein. This Query Files List includes all the query files used by a particular application. The file names and physical path of the files are listed. Every application listed in the global list of registered applications points to one Query Files List. Multiple applications may point to the same Query Files List in response to the applications using the same set of files. It is desired that the Query Files List represent only the files used by a particular application. Every file listed in this Query Files List will have its various hash scans taken and stored in a file with an agreed upon naming syntax, such as: <ApplicationName>-QueryFilesScanFile-<number of files in the list>.txt

Every time an upgrade is made to the query files, this scan file is updated, automatically or manually. This file is stored in encrypted form in preferred embodiments.

In one embodiment, in order for processing to occur, the following logical operations may take place:

1. Orchestrator obtains a file which includes the list of query files/directories (LQFD), a file of binary scans of query files and any other hash scans of files of scans for each registered applications. These details may be entered by application/security administrators manually or fed through files directly.

2. Orchestrator pushes files of list of query files/directories (LQFDs) to all the corresponding registered applications. Files are sent to the ADPL protecting the application. In another embodiment, LQFDs may be packaged with the applications and the ADPL by the DevOps.

3. ADPL receives these files and keeps a copy of it for reference in encrypted or clear text form.

In one embodiment, binary scans of query directories or individual files may be converted to a combined scan for multiple applications and application instances.

The order of operations for protection of application data may take place as described below in one embodiment:

1. Application calls first socket API or other initialization API which gets intercepted by the ADPL

2. Application's executable file scans (MD5Sum, SHA-1,2,256, and/or others) are captured by the ADPL management module for malware checks and application verification processing. The ADPL looks at the List of Query Files (LQFD), and calculates one or more hash scans (such as MD5Sum and SHA binary scans) of each file listed or each file in the directory listed and stores these hash values in another file named “<ApplicationName>-QueryFilesScanFile-<number of files in the table><time & date>.txt”.

Combined hash scans or unique signatures of a file which lists individual hash scans of individual query or other files may be used for comparison with the pre-calculated combined hash scan. This method allows the number of verifications required to detect one or more of files that are altered without permission to be minimized. Then, by identifying the files with recent date or modification, individual files can be identified which were modified or altered.

3. ADPL management module calculates multiple scans of that file.

4. ADPL management module sends a request for verification to the orchestrator which has a master list of registered applications, their scans, associated query files, their scans, and a combined scans of all query files.

5. The request includes an IP address of the host, application name, path, multiple types of binary scans of application file, and multiple scans of combined query file, in one embodiment.

6. The orchestrator performs look-ups on registered applications and checks the multiple scans for a match.

7. The orchestrator also performs look-ups on malware scans to find a match. If a malware match found, the orchestrator returns an error in response with details. It also logs and records all the details of that application and scans including IP address of the requesting host. In response, an alarm or alert is raised.

8. If no malware match is found, the orchestrator performs a look-up and comparison on multiple scans of the associated combined query file scans.

9. If all matches are found, the orchestrator responds with details of the matching files.

10. If all matches are not found, the orchestrator responds with an error message regarding the mismatch or match with the malware scans. The orchestrator logs the details of the query mismatches with scans, application name, time, etc. It may also include calls for ServiceNow web service or escalations, Splunk web calls to feed logs to the splunk analytics engine, etc.

11. The ADPL under the OS API receives the response. If the response suggests error conditions, the API calls exit( ) or other programmed action along with trap, and logs with the details of the caller application. It may also include calls for ServiceNow web service or escalations, Splunk web calls to feed logs to the splunk analytics engine, etc. Some other actions that may be performed include, but are not limited to, killing the failed application, mirroring its interactions, quarantining the failed application, and collecting and logging the details of unauthorized applications and dependent files for analysis.

In order to establish a session, in accordance with one embodiment, the following steps may be followed.

1. Application calls, connects to, or accepts sendto API or receivefrom API or other session initialization API which gets intercepted by the ADPL.

2. ADPL looks at (LQFD) for the calling the application, and calculates signature scans (such as MD5Sum and SHA binary scans) of each file listed or each file in the directory listed and stores it in another file named “<ApplicationName>-QueryFilesScanFile-<no of files in the table><time & date>.txt”. The ADPL management module calculates multiple scans of that file.

3. The ADPL management module sends a request for verification to the orchestrator which has a global list of registered applications, their scans, associated query files, their scans, and a combined scans of all query files.

4. The request includes an IP address of the host, application name, path, multiple types of binary scans of application file, and multiple scans of combined query file.

5. The orchestrator performs look-ups on registered applications and checks the multiple scans for the match.

6. The orchestrator also performs look-ups on malware scans to find a match. If a malware match is found, the orchestrator returns an error in response with details. The orchestrator also logs and records all the details of that application and scans including IP address of the requesting host. Raises alarm.

7. The orchestrator may also include calls for ServiceNow web service or escalations, Splunk web calls to feed logs to the splunk analytics engine, etc.

8. If no malware match is found, the orchestrator performs look-up and comparison on multiple scans of the associated combined query file scans.

9. If all matches are found, the orchestrator responds with details.

10. If all matches are not found, the orchestrator responds with an error message regarding the mismatch. The orchestrator logs the details of the query mismatches with scans, application name, time, etc.

For injected file identification in the ADPL, the following actions may be performed.

1. Perform socket initialization and socket establishment logic.

2. During the above steps of application validation, session query files validation, if orchestrator responds with error about query files validation, look-up-and-isolation algorithm is performed as per next steps.

3. Algorithm:

If caller applications binary scan (hash scan) is correct {

If the hash scan of associated combined query files hash scan is
correct {

Allow the API operations as per ADPL methods.

} else {

Declare that one or more of the query files were altered.
Take a time stamp of that instance.
Create an entry in the error table with the details.
Details may include: index, IP address of the host, Name of
application,

MD5Sum hash scan of application, SHA-256 hash scan of application,
MD5Sum
hash scan of combined query file, SHA-256 hash scan of combined query
file,
time stamp, reason of failure: APP_MD5SUM_MISMATCH,
APP_SHA-
256_MISMATCH, APP_ALL_MISMATCH,
QUERY_MD5SUM_MISMATCH,
QUERY_SHA-256_MISMATCH, QUERY_ALL_MISMATCH,
BOTH_MISMATCH, count of number of times mismatch occurred in the
past,
etc.

Take one of the following actions: reject the operation and exit( )
the

application.(Default action), reject the operation and continue the
application, do
not reject the operation and continue the application, reject the operation
and
find out query files injected (if the reason was query scan mismatch).
Under this
operation, all the files which are updated recently as per the OS time
stamps are
listed. One of those files got altered since last query operation was
performed by
the application, NO-OP, etc.

} else { // applications hash scan mismatched.

Declare that the application file is not valid to exist.
Take a time stamp of that instance.
Create an entry in the error table as above with the details.
Take action: Reject the operation and exit( ) the application.

}

In another embodiment, an interaction control module may manage communications between the ADPL and the orchestrator. Optionally, there may be a module which can co-ordinate interaction between the ADPL and the orchestrator. This module can achieve high availability for ADPL and take advantage of multiple orchestrator modules in load balanced mode (active-active) or active-standby modes.

Interactions between ADPL or components of ADPL and the orchestrator may be performed via web calls (HTITP, HITPS), RPC, simple socket based calls, etc. This includes interactive sharing of data across the connections.

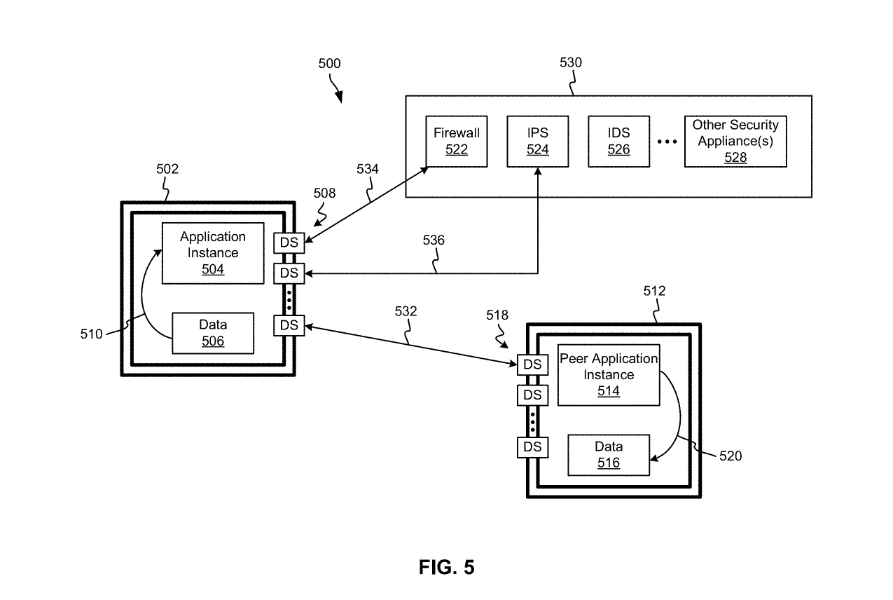

FIG. 5 shows exchange of security capabilities with intermediate device(s) 530 and peer application(s) and application instance(s) 514 in a network 500, according to one embodiment. This exchange may take place in accordance with what is referred to as Security Capabilities Exchange Protocol (SCEP) in one approach.

At application boot up or start time (or some other time shortly after the application instance 504 has begun operating on its host or server), the application instance 504 calls one or more ADPL APIs provided by the ADPL 502 that enable the application instance 504 to inform the ADPL 502 about security capabilities and/or features that are installed and/or accessible to the application instance 504. This information may be exchanged with the ADPL 502 via a protocol data unit (PDU) that is configured to transmit such information, in one embodiment.

In one embodiment, the application instance 504 (and any other application or application instance operating in the network 500) may be configured to access data 506 that is stored for the application instance 504, shown as access operation 510. This operation 510 takes place using conventional APIs and/or routine functionality of the application instance 504, except that any access of the data 506 is protected by the ADPL 502 through API extensions and/or ADPL APIs that piggyback on the conventional APIs used to access the data 506.

Moreover, according to one embodiment, the ADPL 502 protecting the application instance 504 (and any other ADPL protecting an application or application instance operating in the network 500) may be configured to exchange security capability information via one or more data socket descriptors 508 with one or more peer application(s) and/or application instance(s) (shown as peer application instance 514 in FIG. 5, but any number of peer applications and/or application instances may have security capabilities exchanged therewith) via one or more data socket descriptors 518 of the peer application instance 514. The security capabilities are exchanged via the ADPL 502 protecting the application instance 504 that exchanges (sends and/or receives) the security capabilities with an ADPL 512 protecting the peer application instance 514 in exchange operation 532. This exchange 532 may take place during a connection setup process for transmission control protocol (TCP) or before the data exchange for user datagram protocol (UDP) in some approaches, or at some other convenient time. In this way, the ADPL 502 utilizes data socket APIs to exchange security capabilities and/or features of the local application instance 504 with one or more peer application(s) and application instance(s) (e.g., peer application instance 514) operating in the network 500.

For unicast sessions, the capabilities are exchanged per application per server basis in one approach. For multicast sessions, the capabilities are optionally sent over open UDP data sockets in another approach.

Thereafter, the peer application instance 514, upon receiving the security capabilities and/or features of application instance 504 is configured to build a table of security capabilities for each peer application (per host) in the network 500. Moreover, the application instance 504, upon receiving security capabilities and/or features of peer application instance 514 is configured to build a table of security capabilities for each peer application (per host) in the network 500. This allows all peer application(s) and application instance(s) in the network 500 to realize and store the security capabilities and features of all peer applications and application instances in the network 500, so that such functionality may be leveraged in future operations that may be aided by the use of a peer application's security capabilities.

The decision of whether to use security capabilities and/or features of a peer application (e.g., peer application instance 514) in a transmission to/from the peer application and local application (e.g., application instance 504) may be based on a security profile of either the peer application instance 514 and/or the application instance 504 active in the transmission.

Moreover, application instance 504, via one or more APDL APIs, is configured to cause the peer application instance 514 to apply one or more security capabilities and/or features to a corresponding session designated with a data socket descriptor between the application instance 504 and the peer application instance 514.

Any modifications, additions, and/or deletions of security capabilities and/or features on an application or application instance within the network 500 is relayed to all other peer applications and/or application instances via one or more existent sessions between peer applications and/or new sessions established to relay this updated information.

Also, in one embodiment, the peer application instance 514 (and any other application or application instance operating in the network 500) may be configured to store data 516 for the peer application instance 514, shown as store operation 520. This operation 520 takes place using conventional APIs and/or routine functionality of the peer application instance 514, except that storage of the data 516 is protected by the ADPL 512 through API extensions and/or ADPL APIs that piggyback on the conventional APIs used to store the data 516.

In another embodiment, the ADPL 502 protecting the application instance 504 (and any other ADPL protecting an application or application instance operating in the network 500) may be configured to exchange security capability information via one or more data socket descriptors 508 with one or more intermediate devices 530 (such as a firewall appliance 522, an IPS 524 an IPS 524, an IDS 526, other security appliances 528, etc.) in the network 500. For example, in FIG. 5, the ADPL 502 protecting the application instance 504 exchanges (sends and/or receives) security capabilities with a firewall appliance 522 in exchange operation 534 and exchanges (sends and/or receives) security capabilities with an IPS 524 in exchange operation 536.

Thereafter, the one or more intermediate devices 530, upon receiving the security capabilities and/or features of application instance 504, are configured to build a table of security capabilities per session (based on the data socket descriptor used to exchange the security capabilities and/or features of application instance 504) and per application (e.g., application instance 504) in the network 500.

In one embodiment, security risk intelligence sharing may be achieved by sharing abstract or translated information from the security breach incidents caught by the query file injection detection mechanism. This includes, but is not limited to, offending sessions, applications, port numbers, hash scans of the applications or query files, etc. The intelligence may be converted to actionable operations by the other appliances based on the role of the recipient appliance.

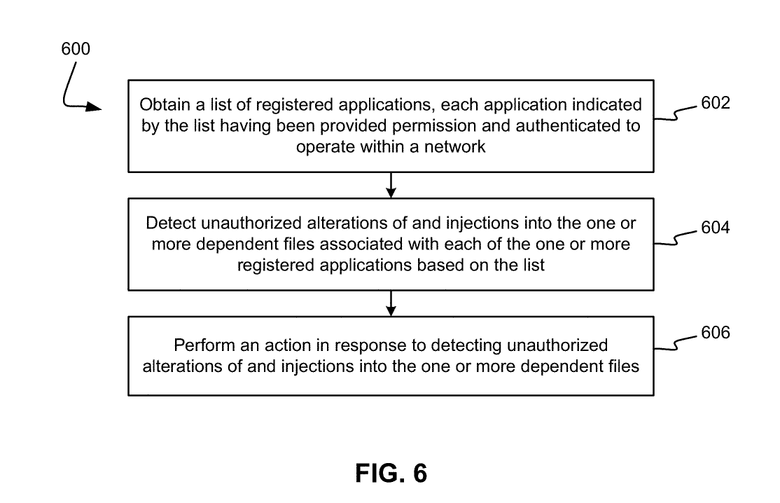

Now referring to FIG. 6, a flowchart of a method 600 is shown according to one embodiment. The method 600 may be performed in accordance with the present invention in any of the environments depicted in FIGS. 1-6, among others, in various embodiments. Of course, more or less operations than those specifically described in FIG. 6 may be included in method 600, as would be apparent to one of skill in the art upon reading the present descriptions.

Each of the steps of the method 600 may be performed by any suitable component of the operating environment. For example, in various embodiments, the method 600 may be partially or entirely performed by a server, host, computing system, processor, switch, or some other device having one or more processing units therein. The processing unit, e.g., processing circuit(s), chip(s), and/or module(s) implemented in hardware and/or software, and preferably having at least one hardware component, may be utilized in any device to perform one or more steps of the method 600. Illustrative processing units include, but are not limited to, a central processing unit (CPU), an ASIC, a FPGA, etc., combinations thereof, or any other suitable computing device known in the art.

As shown in FIG. 6, method 600 may initiate with operation 602, where a list of registered applications is obtained. Each application indicated by the list has been provided permission and authenticated to operate within a network. The provision of permission and authentication to operate with the network may progress according to any technique known in the art, such as strict examination of the application, authorization by an administrator of the network, etc.

The list is a generic term as used herein and may be any known type of data storage mechanism, such as a database, a table, a file, a registry, etc.

In one embodiment, the list comprises an identifier of one or more registered applications. The identifier may be any unique or semi-unique (not totally unique from other applications) alphanumeric, numeric, or alphabetic code or string, such as a name of the application, a registration number, a code associated with the type of application, etc. The list also includes one or more first hash values. Each of the first hash values are obtained individually for each of the one or more registered applications. In other words, there is one hash value in the list for each application in the network that is registered to operate within the network. Each first hash value is stored in correlation with an identifier of a corresponding registered applications. In other words, the first hash value and identifier of a registered application are stored in a correlated manner, such as in the same row of a table.

The list also includes a plurality of second hash values, each of the second hash values are obtained individually for each of one or more dependent files associated with each of the one or more registered applications. In other words, the list includes a second hash value for each dependent file of each registered application. Moreover, the second hash values are stored in correlation with an identifier of a corresponding registered application. In other words, all of the second hash values for a registered application and the identifier of the registered application are stored in a correlated manner, such as in the same row of a table (along with the first hash value).

In operation 604, unauthorized alterations of and injections into the one or more dependent files associated with each of the one or more registered applications are detected based on the list.

In operation 606, an action is performed in response to detecting unauthorized alterations of and injections into the one or more dependent files.

In a further embodiment, method 600 may include generating the first hash values individually from an executable file of each one of the one or more registered applications. In other words, each of the first hash values is generated by applying one or more hashing algorithms to an executable file of an application, preferably the executable file that causes operation of the application. The one or more hashing algorithms are then applied to all other executable files of the other applications that are registered in the network.

Thereafter, method 600 may include generating the plurality of second hash values individually from each of the one or more dependent files associated with each of the one or more registered applications. In other words, each of the second hash values are generated by applying one or more hashing algorithms to each dependent file associated with an application, and repeated for all other applications that are registered in the network.

In these embodiments, the one or more dependent files include all query files associated with each of the one or more dependent files. In this way, any query file that is used in conjunction with an application are considered in whether the application is executing in a normal, anticipated, and authorized manner.

In accordance with one embodiment, detecting unauthorized alterations of and injections into the one or more dependent files may include comparing a hash value obtained from a first file called during operation of a first application within the network with the plurality of second hash values in the list. After this comparison, the first file may be marked as suspicious in response to the hash value obtained from the first file not being in the list. When a hash value obtained from an executing file or file requesting execution is not in the list, then the file may be rogue, corrupted, malicious, or in some other way not authorized to execute within the network.

In these instances, method 600 may include denying any interaction with the first file by any application operating within the network in response to the first file being marked as suspicious.

In a further embodiment, the list may include one or more third hash values. Each of the third hash values are obtained individually for each of the one or more dependent files of the one or more registered applications from a combination of all query files associated with a corresponding one of the one or more dependent files. In other words, the third hash values are generated from applying one or more hashing algorithms to a combination of all dependent files associated with a particular registered application. This process is repeated for each of the registered applications, thereby obtaining one third hash value for each registered application that is based on a combination of all dependent files associated with the registered application.

Moreover, in another embodiment, the list may also include one or more fourth hash values. Each of the fourth hash values are obtained from all applications which are determined to be associated with a query file associated with at least one of the one or more dependent files. In other words, the fourth hash values are generated by applying one or more hashing algorithms to some aspect (such as executable files) of all applications which are known to be associated with a particular query file, thereby providing a reverse lookup mechanism for a query file to determine which applications are registered to access that query file.

In another embodiment, to detect unauthorized alterations of and injections into the one or more dependent files, a hash value obtained from a first file and hash values obtained from all queries related to the first file called during operation of a first application within the network are compared with the second hash values and the third hash values in the list. When a hash value obtained from an executing file, file requesting execution, or queries related to the file, are not in the list, then the file may be rogue, corrupted, malicious, or in some other way not authorized to execute within the network.

In these instances, method 600 may include marking the file as suspicious in response to the hash value obtained from the file and hash values obtained from all queries related to the file not being in the list.

Furthermore, interaction with the first file, by any application operating within the network, may be denied in response to the first file being marked as suspicious. Moreover, interaction with any queries related to the first file, by any application operating within the network, may be denied in response to the queries being marked as suspicious.

In a further embodiment, method 600 may include receiving a request of verification for a first application. The request may include a set of identifying information for the first application, such as an identifier of the first application, multiple hash values obtained from the first application by various hashing methods, a list of first query files used by the first application, a plurality of hash values obtained from the first query files by the various hashing methods, location information for the first query files, etc. In this embodiment, detecting unauthorized alterations of and injections into the one or more dependent files may include comparing the multiple hash values obtained from the first application and the plurality of hash values obtained from the first query files with all hash values included in the list, and sending a verification result to a source of the request.

In one embodiment, the verification result may indicate a matching hash value being found in the list for: each of the multiple hash values obtained from the first application, each of the plurality of hash values obtained from the first query files, and/or a hash value obtained from a combination of the first query files.

Method 600 may be implemented as a system, process, or a computer program product. As a system, method 600 may be implemented on the first host and/or the second host as logic configured to perform method 600, along with being implemented on any other hosts on which secure communications are desired. As a computer program product, a computer readable storage medium may store program instructions configured to perform method 600.

For example, a system may include a processing circuit and logic integrated with and/or executable by the processing circuit. The processing circuit is a non-transitory hardware device configured to execute logic embedded therein, or provided thereto. Examples of processing circuits include, but are not limited to, CPUs, ASICs, FPGAs, microprocessors, integrated circuits, etc. The logic is configured to cause the processing circuit to execute method 600 in one embodiment.

In another example, a computer program product may include a computer readable storage medium having program instructions stored thereon. The computer readable storage medium is a non-transitory device configured to store program instructions that are executable and/or readable by a processing circuit. The program instructions are executable by a processing circuit to cause the processing circuit to perform method 600 in accordance with one embodiment.

Variations of the systems, methods, and computer program products described herein are also possible, and the explicit description thereof in this document is not required in order to provide those of skill in the art with the ability to conceive of such variations when reading the present descriptions.

What is claimed is:

1. A method, comprising:
obtaining a list of registered applications, each application indicated by the list having been provided permission and authenticated to operate within a network, wherein the list comprises:
an identifier of one or more registered applications;
one or more first hash values, each of the one or more first hash values being obtained individually for each of the one or more registered applications and being stored in correlation with an identifier of a corresponding one of the one or more registered applications; and
a plurality of second hash values, each of the plurality of second hash values being obtained individually for each of one or more dependent files associated with each of the one or more registered applications and being stored in correlation with the identifier of the corresponding one of the one or more registered applications;
detecting unauthorized alterations of and injections into the one or more dependent files associated with each of the one or more registered applications based on the list; and
performing an action in response to detecting unauthorized alterations of and injections into the one or more dependent files.

2. The method as recited in claim 1, further comprising:
generating the one or more first hash values individually from an executable file of each one of the one or more registered applications; and
generating the plurality of second hash values individually from each of the one or more dependent files associated with each of the one or more registered applications, wherein the one or more dependent files further include all query files associated with each of the one or more dependent files.

3. The method as recited in claim 1, wherein the detecting unauthorized alterations of and injections into the one or more dependent files further comprises comparing a hash value obtained from a first file called during operation of a first application within the network with the plurality of second hash values in the list, and wherein the performing the action comprises marking the first file as suspicious in response to the hash value obtained from the first file not being in the list.

4. The method as recited in claim 3, wherein the performing the action further comprises denying any interaction with the first file by any application operating within the network in response to the first file being marked as suspicious.

5. The method as recited in claim 1, wherein the list further comprises one or more third hash values, each third hash value being obtained individually for each of the one or more dependent files of the one or more registered applications from a combination of all query files associated with a corresponding one of the one or more dependent files.

6. The method as recited in claim 5, wherein the list further comprises one or more fourth hash values, each fourth hash value being obtained from all applications which are determined to be associated with a query file associated with at least one of the one or more dependent files.

7. The method as recited in claim 5, wherein the detecting unauthorized alterations of and injections into the one or more dependent files further comprises comparing a hash value obtained from a first file and hash values obtained from all queries related to the first file called during operation of a first application within the network with the plurality of second hash values and the one or more third hash values in the list, and wherein the performing the action comprises marking the first file as suspicious in response to the hash value obtained from the first file not being in the list.

8. The method as recited in claim 7, wherein the performing the action further comprises:
denying any interaction, by any application operating within the network, with the first file in response to the first file being marked as suspicious; and
denying any interaction, by any application operating within the network, with any queries related to the first file that are marked as suspicious.

9. The method as recited in claim 1, further comprising:
receiving a request of verification for a first application, the request including an identifier of the first application, multiple hash values obtained from the first application by various hashing methods, a list of first query files used by the first application, a plurality of hash values obtained from the first query files by the various hashing methods, and location information for the first query files,
wherein the detecting unauthorized alterations of and injections into the one or more dependent files further comprises:
comparing the multiple hash values obtained from the first application and the plurality of hash values obtained from the first query files with all hash values included in the list; and
sending a verification result to a source of the request indicating a matching hash value being found in the list for:
each of the multiple hash values obtained from the first application;
each of the plurality of hash values obtained from the first query files; and
a hash value obtained from a combination of the first query files.

10. A computer program product, comprising a computer readable storage medium having program instructions stored thereon, the program instructions being executable by a processing circuit to cause the processing circuit to:
obtain a list of registered applications, each application indicated by the list having been provided permission and authenticated to operate within a network, wherein the list comprises:
an identifier of one or more registered applications;
one or more first hash values, each of the one or more first hash values being obtained individually for each of the one or more registered applications and being stored in correlation with an identifier of a corresponding one of the one or more registered applications; and
a plurality of second hash values, each of the plurality of second hash values being obtained individually for each of one or more dependent files associated with each of the one or more registered applications and being stored in correlation with the identifier of the corresponding one of the one or more registered applications;
detect unauthorized alterations of and injections into the one or more dependent files associated with each of the one or more registered applications based on the list; and
perform an action in response to detecting unauthorized alterations of and injections into the one or more dependent files.

11. The computer program product as recited in claim 10, wherein the program instructions further cause the processing circuit to
generate the one or more first hash values individually from an executable file of each one of the one or more registered applications; and
generate the plurality of second hash values individually from each of the one or more dependent files associated with each of the one or more registered applications, wherein the one or more dependent files further include all query files associated with each of the one or more dependent files.

12. The computer program product as recited in claim 10, wherein the program instructions that cause the processing circuit to detect unauthorized alterations of and injections into the one or more dependent files further causes the processing circuit to compare a hash value obtained from a first file called during operation of a first application within the network with the plurality of second hash values in the list, and wherein the performing the action comprises marking the first file as suspicious in response to the hash value obtained from the first file not being in the list.

13. The computer program product as recited in claim 12, wherein the program instructions that cause the processing circuit to perform the action further causes the processing circuit to deny any interaction with the first file by any application operating within the network in response to the first file being marked as suspicious.

14. The computer program product as recited in claim 10, wherein the list further comprises one or more third hash values, each third hash value being obtained individually for each of the one or more dependent files of the one or more registered applications from a combination of all query files associated with a corresponding one of the one or more dependent files.

15. The computer program product as recited in claim 14, wherein the list further comprises one or more fourth hash values, each fourth hash value being obtained from all applications which are determined to be associated with a query file associated with at least one of the one or more dependent files.

16. The computer program product as recited in claim 14, wherein the program instructions that cause the processing circuit to detect unauthorized alterations of and injections into the one or more dependent files further causes the processing circuit to compare a hash value obtained from a first file and hash values obtained from all queries related to the first file called during operation of a first application within the network with the plurality of second hash values and the one or more third hash values in the list, and wherein the program instructions that cause the processing circuit to perform the action further causes the processing circuit to mark the first file as suspicious in response to the hash value obtained from the first file not being in the list.

17. The computer program product as recited in claim 16, wherein the program instructions that cause the processing circuit to perform the action further causes the processing circuit to:
deny any interaction, by any application operating within the network, with the first file in response to the first file being marked as suspicious; and
deny any interaction, by any application operating within the network, with any queries related to the first file that are marked as suspicious.

18. A system, comprising:
a processing circuit and logic integrated with and/or executable by the processing circuit, the logic causing the processing circuit to:
obtain a list of registered applications, each application indicated by the list having been provided permission and authenticated to operate within a network, wherein the list comprises:
an identifier of one or more registered applications;
one or more first hash values, each of the one or more first hash values being obtained individually for each of the one or more registered applications and being stored in correlation with an identifier of a corresponding one of the one or more registered applications; and
a plurality of second hash values, each of the plurality of second hash values being obtained individually for each of one or more dependent files associated with each of the one or more registered applications and being stored in correlation with the identifier of the corresponding one of the one or more registered applications;
detect unauthorized alterations of and injections into the one or more dependent files associated with each of the one or more registered applications based on the list; and
perform an action in response to detecting unauthorized alterations of and injections into the one or more dependent files.

19. The system as recited in claim 18, wherein the logic further causes the processing circuit to:
generate the one or more first hash values individually from an executable file of each one of the one or more registered applications; and
generate the plurality of second hash values individually from each of the one or more dependent files associated with each of the one or more registered applications, wherein the one or more dependent files further include all query files associated with each of the one or more dependent files.

20. The system as recited in claim 18, wherein the list further comprises one or more third hash values, each third hash value being obtained individually for each of the one or more dependent files of the one or more registered applications from a combination of all query files associated with a corresponding one of the one or more dependent files,
wherein the logic that causes the processing circuit to detect unauthorized alterations of and injections into the one or more dependent files further causes the processing circuit to compare a hash value obtained from a first file and hash values obtained from all queries related to the first file called during operation of a first application within the network with the plurality of second hash values and the one or more third hash values in the list,
wherein the logic that causes the processing circuit to perform the action further causes the processing circuit to:
mark the first file as suspicious in response to the hash value obtained from the first file not being in the list;
deny any interaction, by any application operating within the network, with the first file in response to the first file being marked as suspicious; and
deny any interaction, by any application operating within the network, with any queries related to the first file that are marked as suspicious.
